(19) United States
(12) Patent Application Publication
(10) Pub. No.: US 2012/0219931 A1
(43) Pub. Date: Aug. 30, 2012

(54) SYSTEM, METHOD, AND PROGRAM PRODUCT FOR MODIFYING EATING BEHAVIOR

(76) Inventor: Michael D. Pinnisi, Ithaca, NY (US)

(21) Appl. No.: 13/407,688

(22) Filed: Feb. 28, 2012

Related U.S. Application Data
(60) Provisional application No. 61/447,463, filed on Feb. 28, 2011.

(51) Int. Cl. G09B 19/00

(52) U.S. Cl. 434/127

(57) ABSTRACT

A method to modify weight and nutrition by creating a profile of user behavior and psychological factors; matching that profile to potential behavior changes that have been shown to induce positive change in persons with the user's profile; generating a list of recommended behavior changes for the user that are correlated with positive change for the user's profile; providing the user with a specific plan for adoption of the recommended changes; and modifying the plan over time in response to user experience. Psychological support for the user can be provided to continue in and comply with the plan. The plan can be created and maintained through a website accessed via computer connection to the Internet and the psychological support can be provided by electronic communications.

### RELATIONSHIP TO OTHER APPLICATIONS AND PATENTS

This application draws priority from a pending U.S. Provisional Patent Application Ser. No. 61/447,463, filed Feb. 28, 2011.

### FIELD OF THE INVENTION

The present invention relates to nutrition; more particularly, to methods for controlling human nutrition; and most particularly, to a method for modifying human eating behavior through behavioral techniques in order to regulate body weight and/or to improve nutrition.

### BACKGROUND OF THE INVENTION

There is a serious and increasing worldwide problem of weight gain. The U.S. Centers for Disease Control and other sources estimate that one third of the U.S. population is overweight, and an additional one third is obese. The World Health Organization reports a similar situation in other parts of the world. The problem is accelerating, as the rate at which new persons are becoming overweight is also increasing.

This problem has grown despite a corresponding increase in weight loss programs. A multitude of programs have been available for years, covering a broad range of approaches, such as strict calorie restriction, strict food choice limitations, and medications or supplements. Some are combined with exercise programs. Most rely on some combination of education about nutrition and deprivation of desired kinds or volumes of food in order to cause conscious restriction of caloric intake.

Despite their diversity and popularity, diet programs often fail to induce long-term weight loss. They rely upon will power to overcome the physical and psychological deprivation that is inherent to these programs in order to induce a temporary change of eating behavior that is consistent with weight loss. However, will power is finite, and deprivation can cause physiological effects including slowed metabolism and increased efficiency in conversion of food intake to body fat, and importantly, psychological effects of cravings and binging and other rebound effects that undermine and even outweigh the conscious attempts at caloric restriction.

Because of such factors, many people will not even attempt a weight loss program. Other people start a program, but fail to follow it to success because their limit of will power is exceeded before desired goals are reached. Some lose weight but quickly revert to pre-diet behaviors, and the lost weight quickly returns. Only a small percentage of dieters reach their desired weight and hold it for more than a year or so. Consequently, weight gain continues while millions are dieting and millions more are not even trying.

Deprivation diets thus often fail because they are contrary to human physiology and psychology, attempting to use conscious discipline to overcome natural tendencies to obtain nutrition and enjoy eating.

An effective weight loss method would be better aligned with people's natural physical and psychological tendencies, regulating them over the long term in a manner consistent with steady weight loss and eventual maintenance of healthy weight.

Some examples illustrate the general principle. Research has shown that the amount of food plated is only loosely correlated to the amount of food needed to relieve hunger, but people regularly consume nearly 100% of what they put on their plates, and to provide physical cues of satisfaction they consume that food faster than their bodies can process it. Plating too much food thus causes eating too much food.

Perception and habit influence how much is plated. People tend to serve themselves over 20% more food on a dinner plate that is about 12″ in diameter than one that is about 10″ in diameter, with little or no conscious perception of different volume. They will serve themselves more from a bowl of a given size if provided a larger serving spoon, and they will serve themselves more of the same food from a large serving bowl than a small one, even 50% more under certain conditions. They will take a second helping of food nearly 50% more often if the serving platter is on the dining table within reach of a seated diner than if it is just a few feet away from the table. They will eat more if they are watching television while eating. They rely upon visual and/or social cues rather than internal sensations to decide when to stop eating. They will eat more and enjoy it more if they expect to enjoy the food based upon its name or perceived source. A direct correlation has been shown between the number of people eating together and the amount of food each consumed. Many other examples show that food intake decisions are dominated by perception and other psychological factors rather than by hunger alone.

These factors are powerful in any given session of eating, and have an even greater cumulative effect. Research has shown that people believe they make only about 20 decisions about food daily, when in fact they usually make well over 200 when their decisions are analyzed closely (e.g., whether to eat, choice of foods to consume, size of initial portion, whether to add sweeteners or fats, whether to take additional portions, etc.). These 200+ average daily decisions multiply into thousands of monthly decisions, tens of thousands of annual decisions, and millions of lifetime decisions, many of which are made habitually and with little or no conscious thought.

Different persons can have different kinds of negative eating behaviors, in different combinations. Some eat too much at home meals, or at work lunches, or at restaurants, or at parties. Others snack too often or too much, or eat too much fast food in their cars. Others eat well themselves, but desire to correct negative eating behavior by family members. Some have acceptable caloric intake, but make poor nutritional choices. The individual behaviors and combinations thereof change over time.

Different persons also have different personality traits that affect their eating perceptions and behavior. Some have more objective insight into their behavior than others. Some have more control over their eating environment and food choices. Some have more will power than others. Others differ in degrees of compliant versus oppositional behaviors. Others differ in logical versus emotional components of their eating behaviors. Demographic and other environmental differences can be significant. The traits differ by person, and for any given person over time.

Each of these behavioral and psychological factors and more combine to create a profile of the eater that is a combination of environment, lifestyle, and personality that can explain the cause of the person becoming overweight, and that can provide insight into how to correct unhealthy environmental conditions and behaviors.

Failure to account for these factors can limit or negate the effectiveness of a weight loss program. Even so, most diet programs ignore these factors completely. Others mention them, but offer only general and ineffectual suggestions regarding better conduct that are not targeted to the individual's profile.

It is possible to use psychological factors to induce lower total consumption with little to no conscious perception of change. For example, environmental changes can be made, such as use of smaller serving bowls and dinnerware, and behavioral changes can be made such as eating without television viewing. Specially designed or selected products can be used to induce positive changes, such as wearing of wristbands or clothing as reminders, or placement of reminders for better eating where food is prepared or served or eaten, or means for easy portion control, and other products and environmental changes.

However, not all changes are effective for all people. As noted above, different people have different eating problems, and different decision-making approaches. Any given behavioral changes will be relevant to some people's lifestyles and irrelevant to others. Importantly, any given change will be compatible with the decision-making process of some and incompatible with others. Consequently, any given suggestion for behavior change can reduce, have no effect, or even increase negative behaviors, based upon this combination of factors.

For example, it was found that the suggestion to eat a bowl of oatmeal for breakfast was found to cause weight loss for some, no change for some, and weight gain for others. Those who gained were found to take larger than recommended portions, or to add creams and sweeteners, or even to comply at breakfast but engage in reward or other counterproductive behaviors later in the day. The difference in outcome was explained by the combination of lifestyle and personality that is independent of the behavior of eating oatmeal. Similar effects have been observed regarding other popular tips for better eating and weight loss.

Attempts have been made to induce behavioral changes by publishing suggestions in writings for popular consumption. Many magazine articles have described environmental or conduct changes that can be attempted. This approach is usually ineffectual at best, and counterproductive at worst, inducing weight loss for some who try tips that are incompatible with their behaviors or psychology, and over time they can create or increase a sense of futility for those who try the tips without positive effect.

A somewhat more thorough approach was attempted by Brian Wansink, Ph.D., who published a book regarding research findings in this field (Mindless Eating: Why We Eat More Than We Think, Random House, 2006). Wansink recommends that people adopt one to three changes in their environment and behavior, and track their progress in a written chart.

These instructions by writing, whether by magazine or book, have several inherent obstacles to inducing weight loss. The reader may lack insight regarding which eating behaviors are unhelpful, and thus focus efforts on the wrong problem. Even if negative behaviors are correctly identified, the reader may not know which corrective actions to adopt, given the reader's needs and personality. Even if a correct match is made between negative behavior and potential effective solution, the reader may not know how to adopt the positive behavior as part of the eating routine or other lifestyle aspect. Even if the correct match is made and a good plan for change is formed, the reader may not know how to find the psychological support needed to stick with the plan. Even if there is a correct match, good plan, and support, the reader may not know how to modify the plan over time to keep it relevant and fresh and effective as the person's behaviors and needs change, in order to better ensure lasting change.

To harness the power of these psychological factors, a better method than writings needs to be employed. For example, guidance can be provided by tutoring, either in person or through direct communication such as email. This approach can be highly effective but it obviously is limited by the competence of the instructor and by the logistics of connecting with millions of people who potentially are in need of instruction.

A prior art attempt has been made at an automated process. Wansink and others designed a program called the National Mindless Eating Challenge (“NMEC”). The NMEC provided a computer interface accessed via the Internet that provided suggestions for changes in eating behavior. Users logged into the program, provided demographic and other personal information, and received randomly-assigned suggestions for behavior change. Users returned to the site periodically to report their compliance and their weight, and to receive new suggestions. The project ran for a few months, and the data received from users was later analyzed.

Wansink found that moderately compliant users lost one to two pounds per month on average with little to no conscious sense of deprivation. Wansink correlated collected data regarding weight loss with the randomly-assigned suggestions to determine the efficacy of each for different combinations of eating behaviors and personality characteristics. Wansink also found that greater compliance was reported for users who were assigned changes over those who selected changes themselves, and that greater efficacy was achieved by those who attempted three or fewer changes at any given time.

Although the NMEC process was forward-thinking, it was inherently limited. It used personal user information for data collection and analysis, not for diagnosis and design of a tailored program. It replaced user guesswork about selection of solutions with computer guesswork by random assignment of tips. It did not sort users by type of eating problem or by personality type in order to target solutions. It mixed environmental and behavioral changes. No support was provided in the form of online communication among users or with program staff, or in the form of online reminders or other encouragements. The program was static, in that it did not become more tailored to the individual over time. The NMEC was thus a useful academic tool to collect data that suggested the potential efficacy of any given suggestion for a particular behavior and personality profile, but it did not provide an effective weight management program.

### BRIEF DESCRIPTION OF THE INVENTION

What is needed in the art is a computerized method to regulate a user's weight and nutrition wherein the method systematically takes into account personal user information for diagnosis and design of a tailored program, sorts users by type of eating problem and by personality type in order to target solutions, matches user behavior+personality profiles with environmental and/or behavioral changes that are proven efficacious for their profile, provides support to create and stick with a program in the form of online communication among users or with program staff or in the form of online reminders or other encouragements, and becomes more tailored to the individual over time in response to the individual's continuing experience.

It is a principal object of the invention to provide long-term nutrition and weight loss to a user of the invention.

Briefly described, a computerized method in accordance with the present invention shows that a steady weight loss and eventual maintenance of healthy weight can be achieved by behavioral methods that modify food perception and eating behavior, without reliance upon great will power to enforce the unpleasant effects of deprivation dieting.

Recent research in the field of food psychology shows that eating behavior is more powerfully affected by unconscious and semiconscious factors than previously recognized. Choices regarding food selection, portioning, and total intake are affected materially by a person's eating environment and habitual eating behaviors. Manipulation of these factors can cause changes in consumption in any given eating event of 50% or more with little or no conscience perception of modification of the volume ingested.

Broadly stated, embodiments of the present disclosure offer an improvement over the NMEC approach of randomized suggested solutions provided to an undifferentiated audience of users via the Internet.

In one aspect of the invention, a method is provided including the steps of creating a user profile comprising said user's eating behaviors and pertinent personality traits, matching the user profile to environmental and behavioral changes that are shown to have a likelihood of inducing positive change for said profile, generating a list of recommended environmental and behavioral changes for said user that correlate to said likelihood of inducing positive change, and providing said user with a plan that instructs said user to adopt said environmental and behavioral changes.

In another aspect of the invention, a system is provided to modify a user's eating behavior. The system includes a computer readable system memory comprising at least one program module, a processor coupled to the system memory, and program instructions, stored on the system memory for execution by the processor, to create a user profile comprising said user's eating behaviors and pertinent personality traits. The program instructions match the user profile to environmental and behavioral changes that are shown to have a likelihood of inducing positive change for said profile, generate a list of recommended environmental and behavioral changes for said user that correlate to said likelihood of inducing positive change, and provide said user with a plan that instructs said user to adopt said environmental and behavioral changes.

In yet another aspect of the invention, a computer program product is provided. The computer program product includes a computer readable device storing program code. The program code on the computer readable device, when executed by a processor, provides the functions of: creating a user profile comprising said user's eating behaviors and pertinent personality traits, matching the user profile to environmental and behavioral changes that are shown to have a likelihood of inducing positive change for said profile, generating a list of recommended environmental and behavioral changes for said user that correlate to said likelihood of inducing positive change, and providing said user with a plan that instructs said user to adopt said environmental and behavioral changes.

In one embodiment, a device and/or system and/or method may determine the user's negative eating behaviors; determine the user's pertinent personality traits; combine the findings regarding behavior and personality to form a user profile; match the user's profile with suggested environmental and behavioral changes that are shown by prior research to have a likelihood of inducing positive change for persons matching the user's profile; provide the user with a structured plan that instructs the user regarding how to adopt changes during a defined period of time, which plan incorporates regarding best behavioral research methods in form, duration, and other factors for effective inducement of durable habit change; make adjustments over time to match user experience, progressing to accumulation of healthy behaviors to address a given problem, and to adoption of healthy habits in other categories of behavior over time; and provide psychological support for the user in many forms, including reminders to stay with the plan, a means to communicate privately with other users, and trained program staff to answer questions and address problems and provide encouragement.

Embodiments of the device and/or system and/or method can be fully automated by application of customized computer algorithms and databases, available through an Internet interface, so that creation and support of personalized plans can be performed simultaneously for an essentially unlimited number of users. Over time, the database provides enhanced data regarding the efficacy of particular tips as user experience data for those tips is accumulated.

Embodiments of the device and/or system and/or method can include providing users with recommendations for tangible products to use that have been effective in inducing positive behavior changes for other persons with the user's profile.

Embodiments of the device and/or system and/or method can include providing reference materials, games, quizzes, and other means for user accumulation of knowledge regarding eating behavior.

### DESCRIPTION OF THE DRAWINGS

The foregoing and other objects, features, and advantages of the invention, as well as presently preferred embodiments thereof, will become more apparent from a reading of the following description in connection with the accompanying drawings in which:

FIG. 1 depicts a flow diagram of an exemplary method (e.g., a change suggestion algorithm) in accordance with the present invention;

FIG. 2 depicts a schematic diagram of an exemplary computing device that can be used in implementation of a method such as the method shown in FIG. 1;

FIG. 3 depicts a cloud computing environment according to an embodiment of the present invention; and

FIG. 4 depicts a flow diagram of another exemplary method in accordance with the present invention.

### DETAILED DESCRIPTION OF THE INVENTION

While embodiments of the present disclosure have been particularly shown and described with reference to certain examples and features, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either fewer than or more than the certain number of elements.

A user-friendly website accessed via the Internet is provided for user communication with the program.

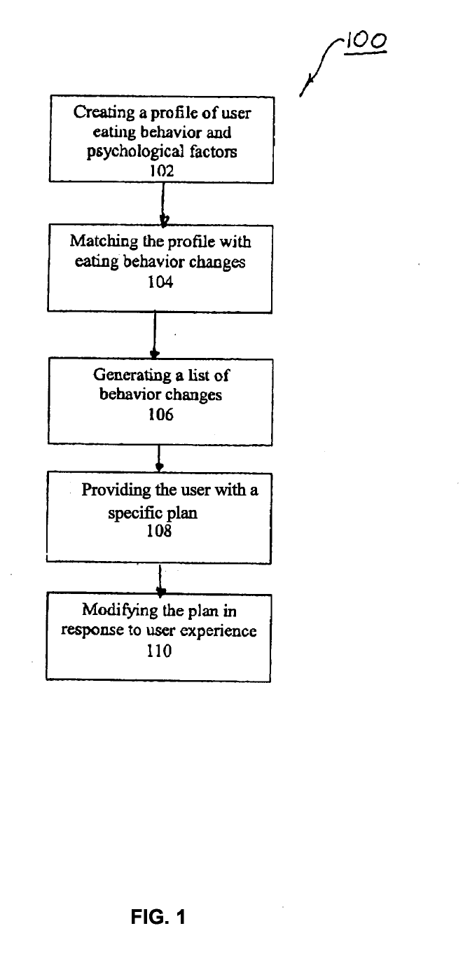

Referring to FIG. 1, an exemplary embodiment of a method 100 is illustrated. The method 100 can comprise, at block 102, creating a profile of user eating behavior and psychological factors and, at block 104, matching the profile with eating behavior changes. The method can also comprise, at block 106, generating a list of behavior changes and, at block 108, providing the user with specific instructions. The method can further comprise, at block 110, modifying the plan in response to user experience.

Other embodiments of, e.g., the method 100, may comprise any one or more of the steps outlined below:

Users are asked to identify their primary goal for the program, such as weight loss, or healthier eating, or improved eating by family members, or even healthy weight gain.

Relevant user behaviors are identified by having users answer a series of standardized true/false or numeric rating questions.

Relevant user psychological traits are identified by having users answer a series of standardized true/false or numeric rating questions.

User behavior and psychological trait answers are analyzed to create profiles of the user's combination of problem area and decision-making type.

The user's profile is matched to recommended behavior changes that are correlated with positive change for known users of such known profiles according to data maintained in a program relational database.

In one embodiment, the matching is accomplished by use of a correlation matrix that has behavior modification tips along the Y axis and different categories of user behavior+trait combinations across the X axis. Values are assigned for each tip/behavior+trait correlation based upon the known likelihood of that match to induce positive change based upon academic research and empirical results obtained through use of the method. The matrix shows values for thousands of possible combinations. The algorithm searches within that matrix for tips with positive values within the user's then-pertinent combination. The algorithm selects three tips with positive values for inclusion in the user's plan, and tracks which tips have been provided in order to avoid repetition over time as the plan is modified based upon user experience.

In one example, a given user may use the method to reduce overeating at restaurants. Modification of restaurant eating is one of many categories in the X axis of the matrix. That category is divided into subcategories based upon the user's personality characteristics, with two subcategories for each criterion (positive/negative), such that five relevant characteristics would result in ten subcategories under restaurant overeating. Some tips will have positive effects for the user's combination of behavior and type, some will have no known effect, and some will have positive effect. Each subgroup column must have an adequate number of positive values to be a viable group. The algorithm can then select tips for the user from that user's specific subcategory. The user's category and/or subcategories will often vary over time, with experience in the program of life changes or both.

The user is provided three recommended changes to adopt for the next 30 days.

The user is provided a limited ability to select and adjust the recommended changes.

The user is required to commit to adopt those changes for the next 30 days.

The user thereby obtains a personalized plan to improve the user's negative eating behavior.

The user is instructed to report compliance with each of the changes recommended in the plan, and is provided graphic representations of that compliance.

The user is instructed to return to the website after 30 days to modify the plan by continuing to work on the same problem with the same solutions, or to work on the same problem with different solutions, or to work on a different problem, or to restart the process altogether.

The user is provided support to maintain interest in and compliance with the program including email messages from staff, automated email and text message reminders, customer service communications by email and phone, and an online community that is restricted to access by other members of the program.

The user is provided encouragement to continue with the plan by posted stories of success experienced by others and by email messages that reinforce this message.

The user is provided additional support in the form of reference materials, links to other helpful web sites, quizzes and games, which assist in greater user understanding of the psychological forces that affect their eating.

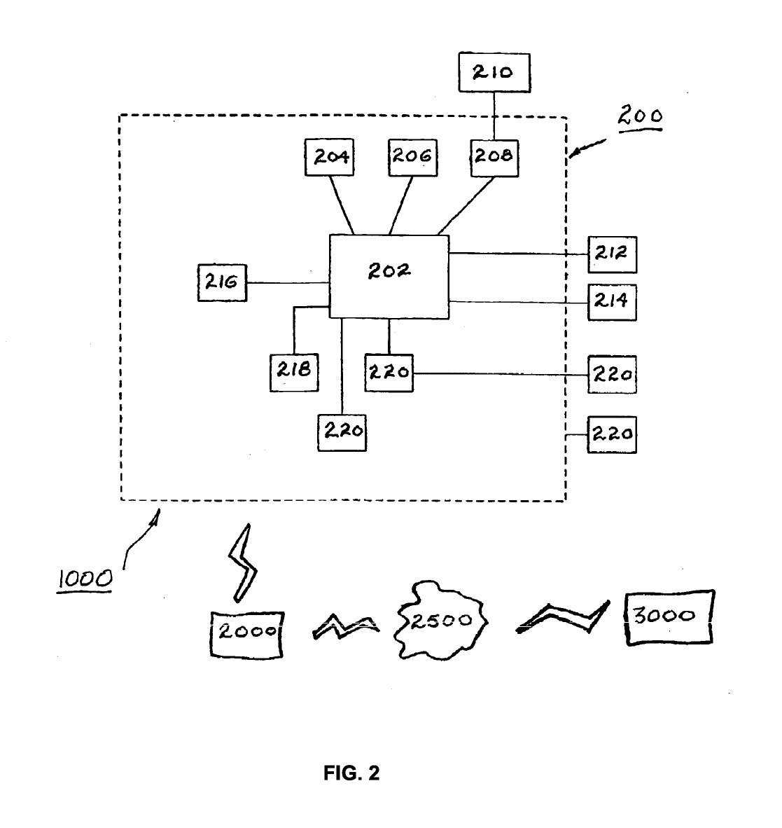

One or more of the steps and functions disclosed and contemplated herein can be implemented on systems constituted by a plurality of devices (e.g., host computer, interface, reader, and printer) or to a single device. By way of example, and with reference to the functional schematic drawing of FIG. 2, there is provided one example of a computing device 200 for use in connection with the systems and methods of the present disclosure.

Referring to FIG. 2, reference numeral 200 designates personal computing equipment such as an IBM PC or PC-compatible computer, laptop, PDA, smartphone, or other device compatible with the concepts disclosed herein. Computing equipment 200 includes a CPU 202 such as a processor, microprocessor or related device that executes stored program instructions such as operator-selected applications programs that are stored in ROM 204 or specialized functions such as start-up programs which are stored in RAM 206. Computing equipment 200 further includes a local area network interface device 208 which provides access to a local area network 210 whereby the computing equipment can access files on a remote file server or send files for remote printing or otherwise interact with a local area network in accordance with known techniques such as by sending or receiving electronic mail.

Computing equipment 200 can further include a monitor 212 for displaying graphic images and a keyboard/mouse 214 for allowing operator designation and inputting functions. Neither of the monitor 212 or the keyboard/mouse 214 are however necessary for implementations of the steps and functions. Moreover, other examples of computing equipment 200 can include other mechanisms for interfacing with the equipment 200, wherein such mechanisms can include touchscreens, touchpads, and the like.

Mass storage memory 216 is connected for access by CPU 202. Mass storage memory 216 typically includes stored program instruction sequences such as an instruction sequence for performing one or more of the steps outlined above, or other application programs such as word processing application programs, optical character recognition programs, spread sheet application programs, and other information and data processing programs. Mass storage memory 216 can also store repositories including data, information and reference tables for use in connection with concepts of present disclosure, and other data as designated by the operator.

A modem 218 such as a wireless interface device, as well as other peripheral devices 220 such as, but not limited to, a facsimile interface and a voice telephone interface can be provided so that CPU 202 can be part of a system 1000 and can interface with external devices including local server 2000 and external server 3000 via network 2500. Thus, CPU 202 can send and receive data, including sending via means other than means 210.

The configuration of the system 1000 can be utilized to process, execute, or implement (collectively, “process”) any one or more of the steps and functions above. In one configuration one or more of the local server 2000 and the remote server 3000 is utilized to entirely process the steps in a manner consistent with this disclosure. In one embodiment, executable instructions related to one or more of the steps can be located outside of the computing device so as to permit data and information to be transferred from the computing device to, e.g., the local server 2000 and/or remote server 3000, for immediate and/or further processing. In another embodiment, processing steps and methodologies disclosed, described, and contemplated herein can be distributed throughout the system 1000 such as between and amongst the computing device, the local server 2000, the remote server 3000, as well as the rest of the system, grid network, and/or cloud computing network, with still other embodiments being configured for the processing steps to be executed entirely by the computing device. Having the processing steps executed exclusively on the computing device can significantly reduce bandwidth required by transferring text rather than audio files. Moreover, this processing can reduce delay from the moment the user chooses an audio versions of a Web site until the audio version is ready to use in the user's (mobile or stationary) computing device.

In view of the foregoing, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may in whole or in part be generally be referred to herein as a “circuit,” “module” or “system,” and “platform.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Objective C, C++ or the like and conventional procedural programming languages, such as the “C” programming language or similar programming languages. The programming language can also be compiled or interpreted as recognized in the art. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer code may likewise be executed on a physical or virtual machine.

There is provided above some aspects of the present disclosure that are described with reference to flowchart illustrations and/or block diagrams of methods, apparatus (systems) and computer program products according to embodiments made in accordance with the concepts and implementations contemplated herein. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In still other embodiments, the system 1000 is or may be part of a cloud or adapted as a cloud computing network with a network of interconnected nodes (e.g., computers, servers, and the like). Cloud computing is a model of service delivery for enabling convenient on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can be characterized in a variety of ways. For example, exemplary cloud computing networks may have:
On-demand self-service: a cloud consumer can unilaterally provision computing capabilities, such as server time and network storage, as needed automatically without requiring human interaction with the service's provider;
Broad network access: capabilities are available over a network and accessed through standard mechanism that promote use by heterogeneous thin or thick client platforms (e.g., mobile phones, laptops, and PDAs);
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter);
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

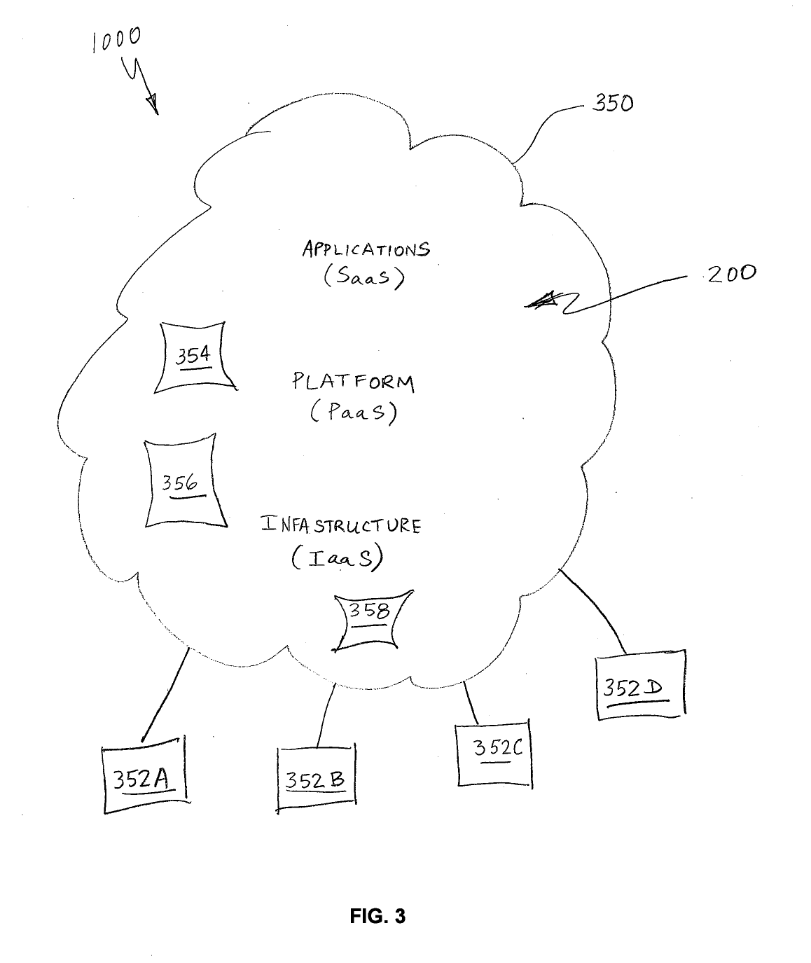

As noted above with reference to FIG. 2, the processing steps and methodologies disclosed, described, and contemplated herein can be distributed throughout the system 1000 such as between and amongst the computing device 200 in a cloud computing network. In this manner, the computing device 200 is generally referred to as a computing node. Turning now to FIG. 3, an illustrative cloud computing environment 350 is depicted. In the illustrated embodiment, cloud computing environment 350 includes one or more cloud computing nodes 200 with which local computing devices 352 used by cloud consumers, such as, for example, cellular or “smart” telephone 352A, desktop computer 352B, laptop computer 352C, and/or tablet computer system 352N may communicate. Nodes 200 may communicate with one another. Although not shown, they may be grouped physically or virtually, in one or more networks, such as Private, Community, Public, or Hybrid clouds as described hereinabove, or a combination thereof. This allows cloud computing environment 350 to offer infrastructure, platforms and/or software as services for which a cloud consumer does not need to maintain resources on a local computing device. It is understood that the types of computing devices 352A-N shown in FIG. 3 are intended to be illustrative only and that computing nodes 200 and cloud computing environment 350 can communicate with any type of computerized device over any type of network and/or network addressable connection (e.g., using a web browser).

The cloud computing environment 350 provides hardware and software components. It should be understood in advance that the components and functions shown in FIG. 3 are intended to be illustrative only and embodiments of the invention are not limited thereto. Examples of hardware components include mainframes, servers, Reduced Instruction Set Computer architecture based (RISC) servers, storage devices, networks, and networking components. Examples of software components include network application server software, application server software, and database software.

The cloud computing environment 350 may further provide virtual entities 354 such as virtual servers, virtual storage, virtual networks, including virtual private networks, virtual applications and operating systems, and virtual clients.

In addition, the cloud computing environment 350 may provide management functions 356 such as resource provisioning for dynamic procurement of computing resources and other resources that are utilized to perform tasks within the cloud computing environment. Management functions 356 may include metering and pricing to provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. A user portal 358 provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

The cloud computing environment 350 provides functionality for which the cloud computing environment may be utilized. For example, functions which may be provided include software development and lifecycle management, data analytics processing, transaction processing, and applications to modify negative behaviors, such as overeating, smoking, or gambling.

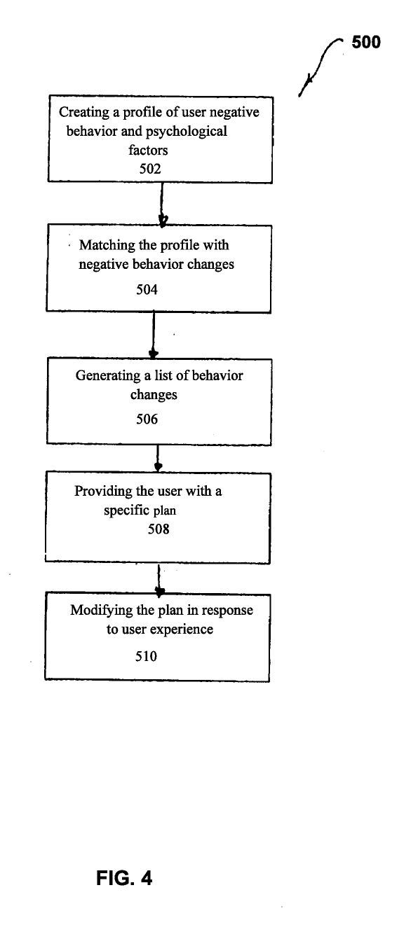

Turning now to FIG. 4, wherein like numbers indicate similar method steps from FIG. 1, another exemplary embodiment of a method 500 is illustrated. The method 500 can provide a means of modifying virtually any negative behavior or habit, such as eating, smoking, or gambling. The method 500 can comprise, at block 502, creating a profile of user negative behavior and psychological factors and, at block 504, matching the profile with appropriate behavior changes. The method can also comprise, at block 506, generating a list of behavior changes and, at block 508, providing the user with specific instructions. The method can further comprise, at block 510, modifying the plan in response to user experience.

Other embodiments of, e.g., the method 500, may comprise any one or more of the steps outlined below:

Users are asked to identify their primary goal for the program, such as weight loss, smoking cessation, or eliminating a gambling habit, for example.

Relevant user behaviors are identified by having users answer a series of standardized true/false or numeric rating questions.

Relevant user psychological traits are identified by having users answer a series of standardized true/false or numeric rating questions.

User behavior and psychological trait answers are analyzed to create profiles of the user's combination of problem area and decision-making type.

The user's profile is matched to recommended behavior changes that are correlated with positive change for known users of such known profiles according to data maintained in a program relational database.

The user is provided three recommended changes to adopt for the next 30 days.

The user is provided a limited ability to select and adjust the recommended changes.

The user is required to commit to adopt those changes for the next 30 days.

The user thereby obtains a personalized plan to improve the user's negative behavior.

The user is instructed to report compliance with each of the changes recommended in the plan, and is provided graphic representations of that compliance.

The user is instructed to return to the website after 30 days to modify the plan by continuing to work on the same problem with the same solutions, or to work on the same problem with different solutions, or to work on a different problem, or to restart the process altogether.

The user is provided support to maintain interest in and compliance with the program including email messages from staff, automated email and text message reminders, customer service communications by email and phone, and an online community that is restricted to access by other members of the program.

The user is provided encouragement to continue with the plan by posted stories of success experienced by others and by email messages that reinforce this message.

The user is provided additional support in the form of reference materials, links to other helpful web sites, quizzes and games, which assist in greater user understanding of the psychological forces that affect their eating.

One or more of the steps and functions 500 disclosed and contemplated herein can be implemented on the systems disclosed herein in reference to FIGS. 2 and 3.

Where applicable it is further contemplated that numerical values, as well as other values that are recited herein are modified by the term “about,” whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The present disclosure has described application of a behavioral system and method to regulate eating behaviors. The systems and methods disclosed may be used alone or in conjunction with a diet and/or exercise program. Furthermore, the same methods and systems can be applied successfully to modify and regulate other behaviors that have a strong psychological component that varies by person and over time, such as smoking cessation, nail biting, possession hoarding, and other habitual and semi-habitual behaviors.

Moreover, while the present disclosure has been particularly shown and described with reference to certain exemplary embodiments, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either fewer than or more than the certain number of elements. Accordingly, the foregoing description should be taken as illustrative and not in a limiting sense.

What is claimed is:

1. A method to modify a user's eating behavior, said method comprising the steps of:
creating a user profile comprising said user's eating behaviors and pertinent personality traits;
matching the user profile to environmental and behavioral changes that are shown to have a likelihood of inducing positive change for said profile;
generating a list of recommended environmental and behavioral changes for said user that correlate to said likelihood of inducing positive change; and
providing said user with a plan that instructs said user to adopt said environmental and behavioral changes.

2. A method in accordance with claim 1 wherein psychological support is provided to induce said user to maintain compliance with said plan.

3. A method in accordance with claim 2 wherein said psychological support is provided by electronic communications.

4. A method in accordance with claim 1 wherein said plan incorporates behavioral research in form, duration, and like factors for effective inducement of durable habit change.

5. A method in accordance with claim 1 wherein said plan is modified over time in response to said user's experience, re-creating said profile, comparing the new profile to said changes, and generating new said recommendations in response to identified changes.

6. A method in accordance with claim 1 wherein said user is provided information regarding eating behavior and eating psychology.

7. A method in accordance with claim 6 wherein said information is provided in a form selected from the group consisting of writing, quizzes, games, graphic representations, and combinations thereof.

8. A method in accordance with claim 1 wherein said user is provided with recommendations for tangible items that have been shown to induce positive eating behavior change in persons with said user's profile.

9. A method in accordance with claim 1 wherein said plan is created and maintained through a website accessed on the Internet via computer equipment and software.

10. A method in accordance with claim 9 wherein said computer equipment is selected from the group consisting of PC, PC-compatible, laptop, PDA, smartphone, processor, microprocessor, ROM, RAM, LAN interface device, WAN, monitor, keyboard, mouse, printer, touchscreen, touchpad, modem, fax, VOIP, local server, external server, cloud computing network, computer-readable storage media, and combinations thereof.

11. A method in accordance with claim 9 wherein said software includes computer program code written in a programming language selected from the group consisting of Java, Objective C, C++, and the like.

12. A method to modify a user's eating behavior, comprising the steps of:
creating a user profile comprising said user's eating behaviors and pertinent personality traits;
utilizing a computer to match said user profile to environmental and behavioral changes that are shown to have a likelihood of inducing positive change for said profile;
generating a computerized list of recommended environmental and behavioral changes for said user;
providing said user with a plan that instructs said user to adopt said environmental and behavioral changes; and
modifying said plan over time in response to user experience.

13. A system to modify a user's eating behavior, comprising:
a computer readable system memory comprising at least one program module;
a processor coupled to the system memory, and
program instructions, stored on the system memory for execution by the processor, to:
create a user profile comprising said user's eating behaviors and pertinent personality traits;
match the user profile to environmental and behavioral changes that are shown to have a likelihood of inducing positive change for said profile;
generate a list of recommended environmental and behavioral changes for said user that correlate to said likelihood of inducing positive change; and
provide said user with a plan that instructs said user to adopt said environmental and behavioral changes.

14. The system of claim 13, wherein the program instructions are provided as a service in a cloud computing environment.

15. The system of claim 13, further including program instructions to determine the user's primary goal for weight and nutrition.

16. A computer program product, comprising:
a computer readable device storing program code; and
the program code on the computer readable device that when executed by a processor provides the functions of:
creating a user profile comprising said user's eating behaviors and pertinent personality traits;
matching the user profile to environmental and behavioral changes that are shown to have a likelihood of inducing positive change for said profile;
generating a list of recommended environmental and behavioral changes for said user that correlate to said likelihood of inducing positive change; and
providing said user with a plan that instructs said user to adopt said environmental and behavioral changes.

17. The computer program product of claim 16, wherein the program code that when executed by the processor provides the function of determine the user's primary goal for weight and nutrition.

18. The computer program product of claim 16, wherein the plan incorporates behavioral research in form, duration, and like factors for effective inducement of durable habit change.

19. The computer program product of claim 16, wherein the program code that when executed by the processor provides the functions of modifying said plan over time in response to said user's experience, re-creating said profile, comparing the new profile to said changes, and generating new said recommendations in response to identified changes.
